(19) United States
(12) Patent Application Publication
(10) Pub. No.: US 2026/0349419 A1
(43) Pub. Date: Nov. 5, 2026

(54) DEVICE AND METHOD FOR AVOIDING DOWNTIMES IN A MACHINE TOOL

(71) Applicant: TRUMPF Werkzeugmaschinen SE + Co. KG, Ditzingen (DE)

(72) Inventors: Manuel Kiefer, Sinsheim (DE); Steffen Schuhmann, Wien (AT)

(21) Appl. No.: 19/708,996

(22) Filed: Jun. 16, 2026

Related U.S. Application Data
(63) Continuation of application No. PCT/EP2024/083789, filed on Nov. 27, 2024.

(30) Foreign Application Priority Data
Dec. 21, 2023 (DE) 10 2023 136 173.2

(51) Int. Cl. G05B 19/418; B23K 26/38

(52) U.S. Cl. CPC G05B 19/41875; B23K 26/38; G05B 2219/49166

(57) ABSTRACT

A device for avoiding downtimes of a tool, including the tool, a safety sensor system, at least one error sensor, and a computing unit. The computing unit is connected to the tool, safety sensor system, and error sensor, and is configured to control the tool according to a production program. The device is configured to identify an error using the error sensor and to identify a risk to the tool using the safety sensor system. The computing unit is configured to stop the tool based on an identification of a risk and, based on a determination that an error of the tool has been identified and a risk to the tool has been excluded, to evaluate the error and, based on the evaluation of the error, to control the tool in deviation from the production program and to continue the production of at least one workpiece part.

### CROSS REFERENCE TO RELATED APPLICATIONS

This application is a continuation of International Application No. PCT/EP2024/083789 (WO 2025/131598A1 ), filed on Nov. 27, 2024, and claims benefit to German Patent Application No. DE 10 2023 136 173.2, filed on Dec. 21, 2023. The aforementioned applications are hereby incorporated by reference herein.

### FIELD

The invention relates to a device for avoiding downtimes of a machine tool and to a method for avoiding downtimes of a machine tool.

### BACKGROUND

DE 10 2015 003 435 A1 discloses a laser processing device in which a processing nozzle is retracted in the event of a power failure.

### SUMMARY

In an embodiment, the present disclosure provides a device for avoiding downtimes of a machine tool, comprising the machine tool, a safety sensor system, at least one error sensor, and a computing unit. The computing unit is connected to the machine tool, the safety sensor system and the error sensor. The computing unit is configured to control the machine tool according to a production program for producing at least one workpiece part. The device is configured to identify an error of the machine tool using the error sensor. The device is configured to identify a risk to the machine tool using the safety sensor system. The computing unit is configured to stop the machine tool based on an identification of a risk to the machine tool. The computing unit is configured, based on a determination that an error of the machine tool has been identified and a risk to the machine tool has been excluded, to evaluate the error and, based on the evaluation of the error, to control the machine tool in deviation from the production program and to continue the production of the at least one workpiece part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a device having a laser cutting machine;

FIG. 2 shows a laser cutting head; and

FIG. 3 shows a laser cutting head with a deflected lower housing.

### DETAILED DESCRIPTION

Embodiments of the present disclosure provide a device and a method for avoiding an error-induced standstill of a machine tool.

The foregoing is achieved by a device for avoiding downtimes of a machine tool, comprising the machine tool, a safety sensor system, at least one error sensor and a computing unit, wherein the computing unit is connected to the machine tool, the safety sensor system and the error sensor, and the computing unit is configured to control the machine tool according to a production program for producing at least one workpiece part, the device being configured to identify an error of the machine tool by means of the error sensor, the device being configured to identify a risk to the machine tool by means of the safety sensor system, the computing unit being configured to stop the machine tool if a risk to the machine tool has been identified, the computing unit being configured, if an error of the machine tool has been identified and a risk to the machine tool has been excluded, to evaluate the error and, depending on the evaluation of the error, to control the machine tool in deviation from the production program and to continue the production of at least one workpiece part.

The device distinguishes between an error sensor and a safety sensor system. A safety sensor system can be designed to identify the entry of persons or objects into a work region of the machine tool. This can be done, for example, using light barriers, radar, and/or ultrasonic sensors. The entry of persons or objects into a work region of the machine tool poses a risk and leads to the immediate stop of the machine tool. An error sensor can be designed to identify abnormal and/or unexpected behavior of the machine tool. Such an error often does not pose a direct risk. Embodiments of the present disclosure make it possible to avoid a standstill of the machine tool in the event of an error that does not pose a risk. By controlling the machine tool in deviation from the production program, the production of at least one workpiece part can be continued despite the error.

In other words, in the event of an error, the computing unit adjusts the production program to the changed conditions and continues the production of the least one workpiece as far as possible. Production is only stopped if a risk is identified by the safety sensor system.

A machine tool can be, in particular, a laser cutting machine, a punching machine or a laser cutting and punching combination machine.

In an advantageous embodiment, the machine tool comprises a laser cutting head, wherein the error sensor is a collision sensor, and the collision sensor is configured to identify a collision of the laser cutting head with an object. The machine tool can, for example, be configured to cut out a large number of workpiece parts from a metal sheet by means of the laser cutting head. A workpiece part that has already been cut out can tilt on the metal sheet support and the laser cutting head can collide with the tilted workpiece part. The collision sensor can identify the collision.

In an embodiment, the device comprises an imaging system in addition to the error sensor, wherein the computing unit is connected to the imaging system, and the computing unit is configured to evaluate an error identified by means of the error sensor using the imaging system. The imaging system provides the computing unit with additional information for evaluating the error. This allows the computing unit to better adjust the control of the machine tool. This is particularly advantageous in combination with the collision sensor. The imaging system can determine the location and type of object with which the laser cutting head has collided. This enables the computing unit to adjust the control of the machine tool accordingly. The imaging system can comprise a camera, a radar sensor, and/or a lidar sensor.

In an embodiment, the computing unit is configured to evaluate the error as either automatically remediable or manually remediable. By distinguishing between manually remediable and automatically remediable errors, the computing unit is able to execute the best strategy to remedy the error.

In an embodiment, the computing unit is configured to control the machine tool to remedy an automatically remediable error. The automatic remedying of the error eliminates the need for manually remedying the error at a later time. After the error has been remedied, the execution of the production program by the computing unit can be continued without adjustment.

In an embodiment, the device has a signal output unit, wherein the computing unit is connected to the signal output unit, and the computing unit is configured to output a signal to an operator by means of the signal output unit in the event of a manually remediable error. The signal output can alert the operator to the necessary manual remedying of the error. This allows the operator to remedy the error promptly, thus avoiding downtime of the machine tool that would otherwise occur later. The computing unit controls the machine tool with an adjusted production program as long as the error exists and production is possible. After manually remedying the error, the execution of the production program by the computing unit can be continued without adjustment.

In an embodiment, the computing unit is configured to identify a remedying of the error, in particular by means of the error sensor, and to put the machine tool into a normal mode after the error has been remedied and to continue the production program. After the error has been remedied, no adjusted control of the machine tool is necessary and the production program can be executed in an unchanged manner by the computing unit.

In an embodiment, the machine tool comprises a cooling system, wherein the error sensor is configured to identify inadequate cooling, and the computing unit is configured to control the machine tool, in particular with reduced power, such that the machine tool produces at least one workpiece part despite inadequate cooling. Inadequate cooling can be caused, for example, by a defect in the cooling system or by incorrect handling. The adjusted control still makes it possible to produce the at least one workpiece part. This is particularly advantageous in the case of a laser cutting machine. Lasers for laser cutting machines often have a power output of several kilowatts and therefore require sufficient cooling. Reducing the laser power increases the processing time, but decreases the cooling requirement, making production possible.

In an embodiment, the machine tool comprises a peripheral component, in particular a pallet changer, a nozzle changer, a loading unit or an unloading unit, wherein the error sensor is configured to detect an error in the peripheral component, the computing unit being configured to control the machine tool such that the machine tool produces the at least one workpiece part without using the faulty peripheral component. An error does not directly lead to a standstill of the machine tool, but production is continued as far as possible without using the faulty peripheral component. For example, if there is an error on the pallet changer, a loading unit or an unloading unit, it is made possible to work with the materials located in the machine tool as long as the faulty peripheral unit is not absolutely necessary. In the case of an error on a nozzle changer, for example on a laser cutting machine, production can be continued with the existing nozzle. This can lead to a reduced quality of the produced workpiece, but avoids downtimes.

The present disclosure also relates to a method for avoiding downtimes of a machine tool, wherein a computing unit controls the machine tool according to a production program, the computing unit stopping the machine tool if a safety sensor system identifies a risk, the computing unit identifying an error by means of an error sensor, the computing unit evaluating the error and, depending on the evaluation, controlling the machine tool in deviation from the production program, and thus production of the at least one workpiece part by means of the machine tool being continued if an error sensor identifies an error and the safety sensor system excludes a risk.

In an embodiment, the error is evaluated as being automatically remediable or manually remediable. By distinguishing between manually remediable and automatically remediable errors, the computing unit is able to execute the best strategy to remedy the error.

In an embodiment, the error is remedied in an automated manner if the error has been evaluated as being automatically remediable. The automatic remedying of the error eliminates the need for manually remedying the error at a later time. After the error has been remedied, the execution of the production program by the computing unit can be continued without adjustment.

In an embodiment, a signal is output to an operator by means of a signal output unit if the error has been evaluated as being manually remediable.

The following description of preferred embodiments serves to explain features of the present disclosure in greater detail with reference to the drawings.

Elements that are the same or have equivalent functions are denoted by the same reference signs in all the exemplary embodiments.

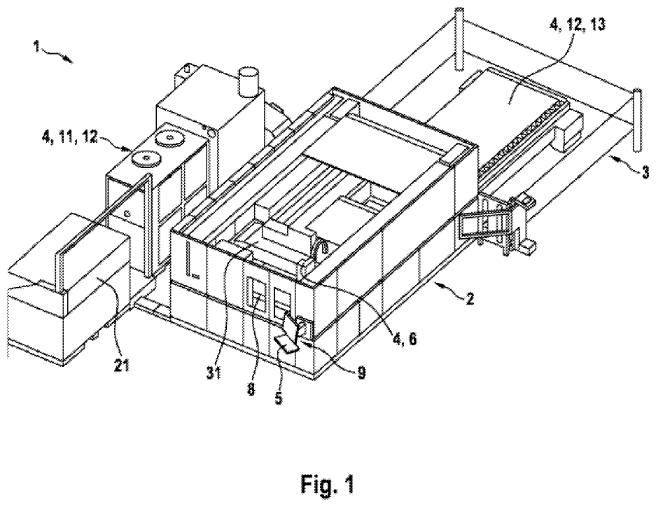

FIG. 1 shows a device 1 having a machine tool 2, here a laser cutting machine. Part of the machine tool 2 is limited by a safety sensor system 3, in this case a light barrier system. By means of the safety sensor system 3, the device is able to identify a risk to the machine tool 2. In this example, the light barrier system 3 can be used to detect when an object enters a safety region of the machine tool 2. The entry of an object into the safety region is evaluated as a risk and leads to an immediate standstill of the machine tool 2.

The machine tool 2 comprises a laser source 21. The laser source 21 generates a laser with which workpiece parts can be cut from a metal sheet in a work region 31 of the machine tool 2. The machine tool 2 comprises a plurality of peripheral components 12. In this example, the peripheral components 12 are a cooling system 11 for cooling the laser source 21 and a pallet changer 13.

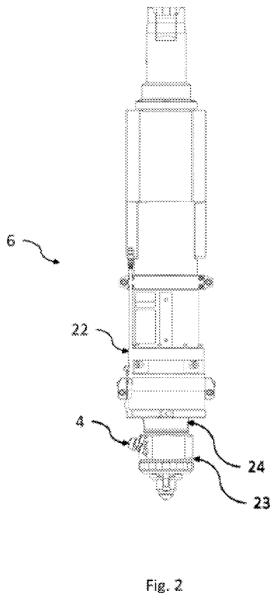

The device 1 also comprises a computing unit 5 and a signal output unit 9. The computing unit 5 is configured to control the machine tool 2 according to a production program for producing at least one workpiece part. For production, the laser is directed from the laser source 21 into the work region 31 and there into a laser cutting head 6, which is described in more detail in connection with FIG. 2. The laser cutting head 6 is moved within the work region 3 over a metal sheet in such a way that contours of the workpiece part are cut into the metal sheet by means of the laser and thus the workpiece part is cut out of the metal sheet. After cutting, the workpiece part is transported out of the work region 31 by means of the pallet changer 13 and a new metal sheet is transported into the work region 31. The device 1 also comprises an imaging system 8, here a camera. The camera 8 is configured such that its field of view is directed towards the work region. The computing unit 5 can output information to an operator via the signal output unit 9, in this case a screen.

The device 1 comprises a plurality of error sensors 4. In this example, error sensors 4 are located on the cooling system 11, on the laser cutting head 6 and on the pallet changer 13. The device can identify errors in the cooling system 11, the laser cutting head 6, or the pallet changer 13 using the error sensors 4. The computing unit 5 is configured to evaluate the error when an error has been identified and a risk to the machine tool 2 has been excluded, and, depending on the evaluation of the error, to control the machine tool 2 in deviation from the production program and to continue production of the at least one workpiece part.

If the error sensor 4 on the cooling system 11 identifies inadequate cooling, the computing unit 5 can evaluate which power of the laser can still be reliably cooled and whether this power is sufficient for the production of the at least one workpiece part. The computing unit then controls the machine tool in deviation from the production program such that at least one workpiece part is produced with reduced laser power and that the cooling capacity is sufficient.

If the error sensor 4 on the pallet changer 13 identifies an error, the computing unit 5 can evaluate whether the function of the pallet changer 13 is necessary for the production of the at least one workpiece part. The computing unit 5 then controls the machine tool 2 in deviation from the production program such that control of the pallet changer is skipped and control of the functions necessary for the production of at least one workpiece part is carried out.

The control of the machine tool 2, in deviation from the production program, is stopped immediately if a risk is identified by means of the safety sensor system 3. If an error is identified by means of an error sensor 4 and a risk is identified by means of the safety sensor system 3, this leads to an immediate standstill of the machine.

FIG. 2 shows a laser cutting head 6. The laser cutting head 6 has an error sensor by which a collision of the laser cutting head 6 with an object can be identified. The laser cutting head 6 has an upper housing part 22 and a lower housing part 23. The laser cutting head 6 has an overload coupling 24 between the upper housing part and the lower housing part 23, which overload coupling is always guided, even in the deflected state, and can thus find its original position again independently.

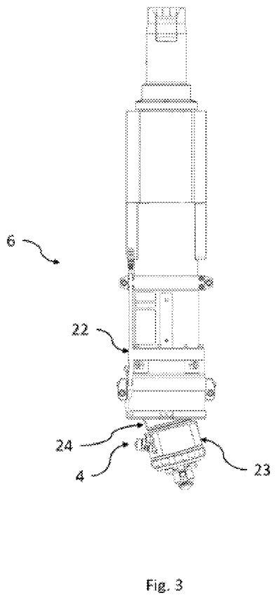

FIG. 3 shows that the lower housing part 23 can be deflected relative to the upper housing part 23 when the laser cutting head 6 collides with an object, for example a cut-out workpiece part. This deflection can be detected by the error sensor 4. The laser cutting head 6 comprises a return arrangement which comprises springs and dampers. The return arrangement aligns the lower housing part 23 with the upper housing part 22 after a collision.

Further details of the laser cutting head 6 are known from DE102021126756A1, the full disclosure of which is hereby incorporated by reference.

If the error sensor 4 on the laser cutting head 6 identifies a collision, the computing unit 5 can evaluate whether a deflection of the lower housing part 23 caused by the collision can be reversed by a traversing movement and use of the return arrangement. The computing unit 5 then controls the machine tool 2 in deviation from the production program such that the laser cutting head is removed from the object with which it has collided and the deflection is reversed. The production program is then continued to produce at least one workpiece part. When evaluating the error on the laser cutting head 6, the computing unit 5 can use images from the camera 8. The images allow the computing unit to identify whether the effect of the collision was so minor that the deflection can be reversed by the return arrangement. In this case, the computing unit 5 evaluates the error as automatically remediable. If the effect of the collision was so severe that the deflection cannot be reversed by the return arrangement, the computing unit 5 evaluates the error as manually remediable and outputs information to an operator via the signal output unit 9.

The error sensor 4 allows the computing unit 5 to identify whether the error has been remedied. Once the error has been remedied, production of at least one workpiece is continued according to the production plan. To identify whether the error has been remedied, data from the camera 8 can also be used by the computing unit 5.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Device
2 Machine tool
3 Safety sensor system
4 Error sensor
5 Computing unit
6 Laser cutting head
7 Object
8 Imaging system
9 Signal output unit
11 Cooling system
12 Peripheral component
13 Pallet changer
21 Laser source
22 Upper housing part
23 Lower housing part
31 Work region

1. A device for avoiding downtimes of a machine tool, comprising:
the machine tool;
a safety sensor system;
at least one error sensor; and
a computing unit,
wherein the computing unit is connected to the machine tool, the safety sensor system and the error sensor,
wherein the computing unit is configured to control the machine tool according to a production program for producing at least one workpiece part,
wherein the device is configured to identify an error of the machine tool using the error sensor,
wherein the device is configured to identify a risk to the machine tool using the safety sensor system,
wherein the computing unit is configured to stop the machine tool based on an identification of a risk to the machine tool, and
wherein the computing unit is configured, based on a determination that an error of the machine tool has been identified and a risk to the machine tool has been excluded, to evaluate the error and, based on the evaluation of the error, to control the machine tool in deviation from the production program and to continue the production of the at least one workpiece part.

2. The device according to claim 1, wherein the machine tool comprises a laser cutting head, wherein the error sensor is a collision sensor, and wherein the collision sensor is configured to detect a collision of the laser cutting head with an object.

3. The device according to claim 1, further comprising an imaging system, wherein the computing unit is connected to the imaging system, and wherein the computing unit is configured to evaluate an error identified by the error sensor using the imaging system.

4. The device according to claim 1, wherein the computing unit is configured to evaluate the error as being automatically remediable or manually remediable.

5. The device according to claim 4, wherein the computing unit is configured to evaluate the error as being automatically remediable and wherein the computing unit is configured to control the machine tool to remedy the automatically remediable error.

6. The device according to claim 4, further comprising a signal output unit, wherein the computing unit is connected to the signal output unit, and wherein the computing unit is configured to output a signal to an operator using the signal output unit based on the error being evaluated to be manually remediable.

7. The device according to claim 1, wherein the computing unit is configured to identify a remedy of the error using the error sensor, and to put the machine tool into a normal mode after the error has been remedied and to continue the production program.

8. The device according to claim 1, wherein the machine tool comprises a cooling system, wherein the error sensor is configured to identify inadequate cooling, wherein the computing unit is configured to control the machine tool with reduced power such that the machine tool produces the at least one workpiece part despite inadequate cooling.

9. The device according to claim 1, wherein the machine tool comprises a peripheral component including a pallet changer, a nozzle changer, a loader or an unloader, wherein the error sensor is configured to identify an error in the peripheral component, and wherein the computing unit is configured to control the machine tool such that the machine tool produces the at least one workpiece part without using the faulty peripheral component.

10. A method for avoiding downtimes of a machine tool, the method comprising:
controlling the machine tool with a computing unit according to a production program;
stopping the machine tool with the computing unit based on a safety sensor system identifying a risk;
identifying an error with the computing unit using an error sensor;
evaluating the error with the computing unit and, based on the evaluation, controlling the machine tool in deviation from the production program to continue production of at least one workpiece part with the machine tool based on the error sensor identifying an error and a safety sensor system excluding a risk.

11. The method according to claim 10, wherein evaluating the error includes evaluating whether the error is automatically remediable or manually remediable.

12. The method according to claim 11, further comprising remedying the error in an automated manner based on the evaluation that the error is automatically remediable.

13. The method according to claim 11, further comprising outputting a signal to an operator using a signal output unit based on the evaluation that the error is manually remediable.
